(19) United States
(12) Patent Application Publication
(10) Pub. No.: US 2003/0161941 A1
(43) Pub. Date: Aug. 28, 2003

(54) Transparent polythiophene layers of high conductivity

(76) Inventors: Stephan Kirchmeyer, Leverkusen (DE); Friedrich Jonas, Aachen (DE)

Correspondence Address: BAYER CHEMICALS CORPORATION, 100 BAYER ROAD, PITTSBURGH, PA, 15205, US

(21) Appl. No.: 10/365,981

(22) Filed: Feb. 13, 2003

(30) Foreign Application Priority Data
Feb. 15, 2002 (DE) 10206294.3

(51) Int. Cl. B05D 5/12

(52) U.S. Cl. 427/58

(57) ABSTRACT

Process for the production of transparent, electrically conductive polythiophene layers having a specific conductivity of at least 500 S/cm by polymerization of a thiophene or of a mixture of various thiophenes by chemical oxidation, where the oxidants employed are iron(III) salts of alicyclic sulphonic acids, to layers obtainable in this way and to the use thereof.

### BACKGROUND OF THE INVENTION

1. Field of the Invention

The invention relates to a process for the production of transparent, electrically conductive layers having a conductivity of at least 500 S/cm, to corresponding layers, and to the use thereof.

2. Brief Description of the Prior Art

Layers of polythiophenes, the production thereof by electrochemical or chemical oxidation of suitable thiophenes, and the use thereof for the antistatic finishing of substrates which do not conduct electrical current, or only do so poorly, are known.

EP 206 133 A1 describes a process for the application of layers of conductive, polymeric, heterocyclic compounds prepared with the aid of oxidants to substrates which do not conduct current or only do so poorly. The conductivities of the polymers which can be prepared in accordance with EP 206 133 A1 are a maximum of 100 S/cm.

EP 253 594 A2 describes in particular thiophenes which are substituted in the 3-and/or 4-position by optionally substituted alkyl and/or alkoxy groups, and the electrically conductive polymers obtained therefrom by chemical or electrochemical oxidation. The polymers and copolymers described in EP 253 594 A2 which are prepared by chemical oxidation only have conductivities of up to 0.05 S/cm. If the polymers or copolymers are prepared by electrochemical oxidation, conductivities of up to 1050 S/cm can be achieved. However, a disadvantage of electrochemical oxidation is that this procedure is significantly more complex than chemical oxidation owing to the apparatus required. In addition, the polymers obtained by electrochemical oxidation are substantially insoluble, which greatly restricts their potential uses. Electrochemical oxidation generally only allows homogeneous polymer films to be produced in a layer thickness of up to about 200 mn; above this value, they have only low mechanical strength and are very rough.

U.S. Pat. No. 4,521,589 describes the preparation of polymeric 3-alkylthiophenes by reaction of 3-alkyl-2,5-dihalothiophenes with magnesium in the presence of nickel compounds in inert organic solvents. The electrical conductivity of the polythiophenes obtained in this way is given as 9×10⁻¹⁴ S/cm. The conductivity can be increased to about 0.5 S/cm by reaction with iodine.

EP 203 438 A1 and EP 257 573 A1 describe the preparation of substituted conductive polythiophenes which are soluble in organic solvents and the use of the solutions of these soluble polythiophenes for the antistatic finishing of substrates which do not conduct electrical current, or only do so poorly. The conductivities of the polythiophenes described in EP 203 438 A1 is preferably greater than 10⁻² S/cm, it only being possible to obtain such conductivities by doping the polymers with electron donors, for example iodine. Even after doping, conductivities of only up to a maximum of 15 S/cm are described. According to EP 257 573 A1, polythiophenes having conductivities of up to 100 S/cm can be prepared by electrochemical polymerization.

EP 339 340 A2 describes 3,4-substituted polythiophenes which can be prepared by oxidative polymerization of the corresponding thiophenes. The oxidants described include iron(III) salts of organic acids, and inorganic acids carrying organic radicals. For example, iron(III) salts of C₁-C₂₀-alkylsulphonic acids and of aromatic sulphonic acids are mentioned. The layers which can be produced from the polythiophenes only have conductivities of from 0.01 to 10 S/cm. Here too, the conductivities can be increased to 200 S/cm if the oxidation is not carried out chemically, but instead electrochemically. The disadvantages associated therewith have already been described above.

EP 820 076 A2 describes capacitors having solid electrolytes comprising electrically conductive polymers. The solid electrolytes consist of polymers of pyrroles, thiophenes, furans, anilines or derivatives thereof which have been doped with polysulphonic acids, organic sulphonic acids having hydroxyl groups or carboxyl groups, alicyclic sulphonic acids or a benzoquinonesulphonic acid. EP 820 076 A2 describes the impregnation of tantalum foils having a large surface area which scatters the light. The solid electrolytes described in EP 820 076 A2 are therefore not transparent, but instead opaque. There is no indication that the solid electrolytes described in EP 820 076 A2 have particular conductivity. According to EP 820 076 A2, conductivities of from 10 to 100 S/cm are sufficient for use of a polymer layer as solid electrolyte. No details are given on the production of polymer layers of higher conductivity.

However, particularly high conductivity is necessary for a multiplicity of applications, and consequently the object of the present invention is to provide electrically conductive layers having particularly high conductivity which, in addition, are distinguished by high transparency.

### SUMMARY OF THE INVENTION

Surprisingly, it has been found that transparent, electrically conductive layers of particularly high conductivity can be produced using polymers prepared by chemical oxidation of suitable thiophenes, where the oxidants used are iron(III) salts of alicyclic sulphonic acids.

The invention therefore relates to a process for the production of transparent, electrically conductive layers having a conductivity of greater than 500 S/cm by polymerization of one or more thiophenes of the general formula (I)

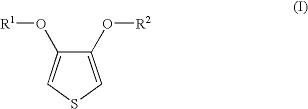

in which

R¹ and R², independently of one another, are an optionally substituted, linear or branched alkyl radical, aryl radical, alkylaryl radical or heterocyclic radical having from 1 to 10 carbon atoms, or R¹ and R² together are a linear or branched, substituted or unsubstituted alkylene radical having from 1 to 18 carbon atoms,

where the polymerization is carried out by chemical oxidation and the oxidants employed are iron(III) salts of alicyclic sulphonic acids.

### DETAILED DESCRIPTION OF THE INVENTION

R¹ and R² are preferably, independently of one another, a linear or branched alkyl radical having from 1 to 6 carbon atoms, C₆-C₁₀-aryl or C₁-C₆-alkyl-C₆-C₁₀-aryl, or R¹ and R² together are a linear, optionally substituted alkylene radical having from 1 to 10 carbon atoms.

The invention furthermore relates to the layers obtainable in this way and to the use of these electrically conductive layers.

The process according to the invention is preferably carried out using compounds of the general formula (II)

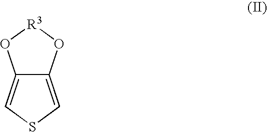

in which

R³ is —(CH₂)ₘ—CR⁴R⁵—(CH₂)n—, where

R⁴ and R⁵ are identical or different and are hydrogen, a linear or branched alkyl radical having from 1 to 18 carbon atoms, OH, O—CH₂—CH₂—CH₂—SO₃H or O-alkyl having 1-18 carbon atoms, and

n and m are each, independently of one another, an integer from 0 to 9, where the sum n+m is≦9.

R⁴ and R⁵ are preferably, independently of one another, hydrogen, a linear alkyl radical having from 1 to 6 carbon atoms, OH, O—CH₂—CH₂—CH₂—SO₃H or O-alkyl having from 1 to 6 carbon atoms. R⁴ and R⁵ are particularly preferably hydrogen.

Examples of compounds which can be employed in the process according to the invention are dimethoxythlophene, diethoxythiophene, dipropoxythiophene, dibutoxythiophene, methylenedioxythiophene, ethylenedioxythiophene, propylenedioxythiophene, butylenedioxythiophene, thiophenes which are substituted by hydroxyl or alkoxy groups, as described, for example, in U.S. Pat. No. 5,111,327, thiophenes carrying CH₂—O—(CH₂)ₙ—SO₃H groups, where n is an integer from 2 to 10, and ethylenedioxythiophenes which are substituted by an alkyl group, preferably C₁-C₁₀-alkyl.

The iron(III) salts which can be employed in the process according to the invention are iron(III) salts of alicyclic sulphonic acids. The sulphonic acids on which the iron(III) salts are based are sulphonic acids which contain an alicyclic ring having from 4 to 20 carbon atoms and one or more sulphonic acid groups.

Examples of alicyclic sulphonic acids which can be employed in the process according to the invention are: cyclohexanesulphonic acid, methylcyclohexanesulphonic acid, cycloheptanesulphonic acid, camphorsulphonic acid and sulphonic acids which can be prepared, for example, by hydrogenation of aromatic sulphonic acids.

The process according to the invention can preferably be carried out using iron(III) salts of camphorsulphonic acid, it being possible to use iron(III) (+)-camphorsulphonate, iron(III) (−)-camphorsulphonate, the racemate of iron(III) (+)-camphorsulphonate and iron(III) (−)-camphorsulphonate, or any desired mixtures of iron(III) (+)-camphorsulphonate and iron(III) (−)-camphorsulphonate.

The addition of further oxidants and/or of dopants is not necessary and is preferably avoided.

Carrying out the process according to the invention gives rise to electrically conductive, transparent layers which contain polythiophenes having positive charges in the polymer chain and counterions which compensate for this charge. The polymers present in the layers which can be produced by the process according to the invention can be illustrated in a simplified and diagrammatic manner by the formula (III):

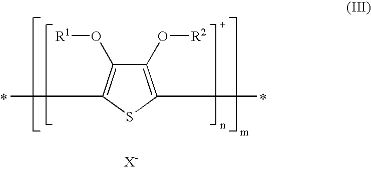

where

R¹ and R² are as defined above,

X⁻is the corresponding sulphonate ion of the iron(III) salt of an alicyclic sulphonic acid employed in the process according to the invention, and

n is on average a number from 1 to 20 and m is on average a number from 2 to 10,000.

The oxidative polymerization of the thiophenes of the formulae I and II by chemical oxidation can generally be carried out, depending on the desired reaction time, at temperatures of from −10 to +250° C., preferably at temperatures of from 0 to 200° C.

An organic solvent which is inert under the reaction conditions is frequently added to the thiophene to be employed, giving a coating solution which can be applied to a substrate. Examples of inert organic solvents which may be mentioned are, in particular: aliphatic alcohols, such as methanol, ethanol and propanol; aliphatic ketones, such as acetone and methyl ethyl ketone; aliphatic carboxylic acid esters, such as ethyl acetate and butyl acetate; aromatic hydrocarbons, such as toluene and xylene; aliphatic hydrocarbons, such as hexane, heptane and cyclohexane; chlorinated hydrocarbons, such as dichloromethane and dichloroethane; aliphatic nitrites, such as acetonitrile; aliphatic sulphoxides and sulphones, such as dimethyl sulphoxide and sulpholane; aliphatic carboxamides, such as dimethylacetamide, dimethylformamide and N-methylpyrrolidone; aliphatic and araliphatic ethers, such as diethyl ether and anisole. It is furthermore also possible for the solvent used to be water or mixtures of water with the above-mentioned organic solvents, as long as the latter are miscible with water.

The oxidative polymerization of the thiophenes of the formulae I and II theoretically requires 2.25 equivalents of oxidant per mole of thiophene (see, for example, J. Polym. Sc. Part A, Polymer Chemistry Vol. 26, p. 1287 (1988)). In practice, however, the oxidant is used in a certain excess, for example an excess of from 0.1 to 2 equivalents per mole of thiophene.

The transparent, electrically conductive layers can be produced by joint or separate application of thiophene and oxidant. For separate application, a substrate to be coated is firstly treated with the solution of the oxidant and subsequently with the solution of the thiophene. In the case of joint application of thiophene and oxidants, a substrate to be coated is generally coated only with a solution comprising thiophene and oxidants. Since some of the thiophene evaporates in the case of joint application, a smaller amount of oxidant corresponding to the expected loss of thiophene is added to the solutions.

Before production of the coatings, binders and/or crosslinking agents, such as polyurethanes, polyacrylates, polyolefins, epoxysilanes, such as 3-glycidoxy-propyltrialkoxysilane, can be added to the coating solutions. Furthermore, silanes or silane hydrolysates, for example based on tetraethoxysilane, can be added in order to increase the scratch resistance in coatings.

The coating solutions to be applied to the substrates to be coated preferably comprise from 1 to 30% by weight of the corresponding thiophene of the formula I and/or II and from 0 to 30% by weight of binder, both percentages by weight being based on the total weight of the solution. The coating solutions can be applied to the substrates by known methods, for example by spraying, knife coating, spin coating, brushing or printing.

After application of the coating solutions, the solvent can be removed by simple evaporation at room temperature. In order to achieve relatively high processing speeds, however, it is advantageous to remove the solvents at elevated temperatures, for example at temperatures of from 20 to 250° C., preferably from 40 to 200° C.

The removal of the solvents at elevated temperature is also advantageous since it has been found that the electrical conductivity of the layers according to the invention can be increased by heat treatment of the coating at temperatures of from 50 to 250° C., preferably from 100 to 200° C. The thermal aftertreatment can be carried out immediately after removal of the solvent, but also at a time interval after production of the coating.

After removal of the solvents (drying), it may be advantageous to wash the excess oxidant out of the coating. Suitable for this purpose is water, optionally mixed with organic sulphonic acids, or lower alcohols, such as, for example, methanol and ethanol.

The substrates which can be coated by the process according to the invention are, in particular, inorganic transparent substrates made from glass, silicon dioxide and ceramic materials and sheet-like transparent substrates made from organic plastics, for example transparent films made from polycarbonate, polyamide, polyolefins or polyesters. The substrates can, if desired, be coated with adhesion promoters, such as, for example, silanes, before the actual coating, for example in order to produce better adhesion.

The layer thickness of the coating applied can generally be, after drying, from 0.01 to 100 μm, depending on the desired conductivity and the desired transparency of the coating.

The transparent, electrically conductive layers which can be produced by the process according to the invention have a specific electrical conductivity of at least 500 S/cm, preferably a specific electrical conductivity of at least 1000 S/cm. The specific conductivity is determined by measurement of the layer thickness by means of a profilometer and measurement of the surface resistance (2×2 cm measurement strips, resistance measurement by means of a commercially available resistance meter) or by means of a commercially available four-point measuring instrument.

The layers have high optical transparency. The optical transparency is preferably at least 50%, particularly preferably at least 75%. The optical transparency is determined here by means of transmission measurement using a commercially available UV-VIS spectrometer in the region of visible light (300-800 nm) and formation of the numerical average from at least three individual values.

The invention furthermore relates to transparent conductive layers which are obtainable by the process according to the invention.

The electrically conductive, transparent layers according to the invention are suitable, for example, for finishing plastic films for the packaging of electronic components and for clean-room packaging, for the antistatic finishing of cathode-ray ray tubes, for the antistatic finishing of photographic films, as transparent heating, as transparent electrodes, circuit boards or of window panes which can be coloured electrically.

The invention is further illustrated but is not intended to be limited by the following examples in which all parts and percentages are by weight unless otherwise specified.

### EXAMPLES

Specific conductivities were determined by measurement of the layer thickness (profilometer) and measurement of the surface resistance (2×2 cm measurement strips, resistance measurement by means of a commercially available resistance meter) or by means of a commercially available four-point measuring instrument.

### Example 1

0.25 g of ethylene-3,4-dioxythiophene (1.76 mmol) and 5.0 g (13.3 mmol) of a 54 per cent by weight iron(III) camphorsulphonate solution in butanol were dissolved in one another and applied to glass plates with the aid of a commercially available spin-coater at various rotational speeds. The coated glass plates were dried at room temperature and conditioned for a further one hour at 80° C. After cooling, the glass plates were washed with water and dried. The layer thicknesses and specific conductivities are shown in Table 1.

TABLE 1

| Rotational speed | Specific conductivity in S/cm | Layer thickness in nm |
|---|---|---|
| 1500 | 1035 | 420 |
| 2000 | 1276 | 340 |

Comparative Example 1

0.25 g of ethylenedioxythiophene (1.76 mmol) and 5.0 g (3.80 mmol) of a 40% by weight iron(III) p-toluenesulphonic acid solution in butanol were dissolved in one another and applied to glass plates with the aid of a commercially available spin-coater at various rotational speeds. The coated glass plates were dried at room temperature and conditioned for a further one hour at 80° C. After cooling, the glass plates were washed with water and dried. The layer thicknesses and specific conductivities are shown in Table 2.

TABLE 2

| Rotational speed | Specific conductivity in S/cm | Layer thickness in nm |
|---|---|---|
| 500 | 119 | 380 |
| 1000 | 122 | 240 |

Comparative Example 2

0.25 g of ethylenedioxythiophene (1.76 mmol) and 5.0 g (3.80 mmol) of a 43.6% by weight iron(III) phenol-4-sulphphonic acid solution in butanol were dissolved in one another and applied to glass plates with the aid of a commercially available spin-coater at various rotational speeds. The glass plates were dried at room temperature and conditioned for a further one hour at 80° C. After cooling, the glass plates were washed with water and dried. The layer thicknesses and specific conductivities are shown in Table 3.

TABLE 3

| Rotational speed | Specific conductivity in S/cm | Layer thickness in nm |
|---|---|---|
| 500 | 2.5 | 1300 |

Comparative Example 3

0.25 g of ethylenedioxythiophene (1.76 mmol) and 5.0 g (3.80 mmol) of a 25.9% by weight iron(III) methanesulphonic acid solution in butanol were dissolved in one another and applied to glass plates with the aid of a commercially available spin-coater at various rotational speeds. The coated glass plates were dried at room temperature and conditioned for a further one hour at 80° C. After cooling, the glass plates were washed with water and dried. The layer thicknesses and specific conductivities are shown in Table 4.

TABLE 4

| Rotational speed | Specific conductivity in S/cm | Layer thickness in nm |
|---|---|---|
| 500 | 102 | 1300 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for the production of transparent, electrically conductive layers having a specific conductivity of at least 500 S/cm by polymerization of a thiophene of the general formula (I) or of a mixture of various thiophenes of the formula (I) 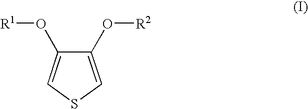
in which
R¹ and R², independently of one another, are an optionally substituted, linear or branched alkyl radical, aryl radical, alkylaryl radical or heterocyclic radical having from 1 to 10 carbon atoms,
or R¹ and R² together are a linear or branched, substituted or unsubstituted alkylene radical having from 1 to 18 carbon atoms,
comprising conducting the polymerization by chemical oxidation, where the oxidants employed are iron(III) salts of alicyclic sulphonic acids.

2. Process for the production of transparent, electrically conductive layers according to claim 1, wherein the thiophene used is a compound of the formula (II) 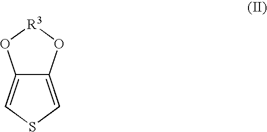
in which
R³ is —(CH₂)ₘ—CR⁴R⁵—(CH₂)ₙ—, where
R⁴ and R⁵, independently of one another, are hydrogen, a linear or branched alkyl radical having from 1 to 18 carbon atoms, OH, O—CH₂—CH₂—CH₂—SO₃H or O-alkyl having from 1 to 18 carbon atoms, and
n and m are each, independently of one another, an integer from 0 to 9, where the sum n+m is≦9.

3. Process for the production of transparent, electrically conductive layers according to claim 1, wherein the thiophene used is 3,4-ethylenedioxythiophene.

4. Process for the production of transparent, electrically conductive layers according to claim 1, wherein the iron(III) salt used is iron(III) camphorsulphonate.

5. Process for the production of transparent, electrically conductive layers according to claim 1, wherein the transparency of the conductive layers is at least 50 per cent.

6. Process for the production of transparent, electrically conductive layers according to claim 1, wherein the specific conductivity of the transparent, electrically conductive layers is at least 1000 S/cm.

7. Electrically conductive layer obtainable by a process according to claim 1.

8. A method of preparing an article of matter useful for the finishing of plastic films for the packaging of electronic components, for clean-room packaging, antistatic finishing of cathode-ray tubes, antistatic finishing of photographic films, as transparent heating, as transparent electrodes, circuit boards or of window panes which can be coloured electrically comprising providing the electrically conductive layers according to claim 7.
